(19) United States
(12) Patent Application Publication
(10) Pub. No.: US 2024/0128793 A1
(43) Pub. Date: Apr. 18, 2024

(54) POWER STATION OPERATION AND MAINTENANCE SYSTEM, POWER STATION OPERATION AND MAINTENANCE METHOD, AND PHOTOVOLTAIC POWER STATION

(71) Applicant: Huawei Digital Power Technologies Co., Ltd., Shenzhen (CN)

(72) Inventors: Yanzhong ZHANG, Shenzhen (CN); Zhenhuan SHU, Suzhou (CN); Jianqiang WANG, Shanghai (CN)

(73) Assignee: Huawei Digital Power Technologies Co., Ltd., Shenzhen (CN)

(21) Appl. No.: 18/398,782

(22) Filed: Dec. 28, 2023

Related U.S. Application Data
(63) Continuation of application No. PCT/CN2021/103048, filed on Jun. 29, 2021.

(51) Int. Cl. H02J 13/00; H02J 3/00

(52) U.S. Cl. CPC H02J 13/00034; H02J 3/0012; H02J 13/00001; H02J 13/00002; H02J 2203/10; H02J 2203/20; H02J 2300/24

(57) ABSTRACT

A data processing system in the power station operation and maintenance system may determine a faulty module and a normal module based on module data of each photovoltaic module in a photovoltaic string, and obtain first power generation data of the faulty module and second power generation data of the normal module. Further, the data processing system may determine an annual lost energy yield of the faulty module based on the first power generation data, the second power generation data, and a preset energy yield of the photovoltaic power station, and obtain a target operation and maintenance measure from a plurality of operation and maintenance measures based on the annual lost energy yield. In this case, a communication system in the power station operation and maintenance system may notify an operation and maintenance user of the photovoltaic power station to perform operation and maintenance on the faulty module.

### CROSS-REFERENCE TO RELATED APPLICATIONS

This application is a continuation of International Application No. PCT/CN2021/103048, filed on Jun. 29, 2021, the disclosure of which is hereby incorporated by reference in its entirety.

### TECHNICAL FIELD

The embodiments relate to the field of power electronics technologies and to a power station operation and maintenance system, a power station operation and maintenance method, and a photovoltaic power station.

### BACKGROUND

Over time, different types of faulty modules (for example, a faulty module that has a hidden crack, shading, degradation, and performance deterioration) may appear in a photovoltaic power station. An energy yield of the faulty module decreases, and this even affects an energy yield of a module connected in series/parallel to the faulty module. Therefore, how to find a faulty module and increase an energy yield of the faulty module is especially important.

In the conventional technology, an IV curve of a photovoltaic string may be scanned by using a photovoltaic controller, and a health diagnosis may be performed on the IV curve of the photovoltaic string to detect a faulty photovoltaic string. However, positioning and detection of a faulty module in the faulty photovoltaic string and replacement of the faulty module need to be performed manually. Costs of manually performing positioning and detection and module replacement are excessively high. In another conventional technology, an image of a photovoltaic module may be collected by using a thermal infrared camera, fault identification is performed on the image of the photovoltaic module based on an image fault identification algorithm, to obtain a faulty module, and whether the faulty module needs to be replaced is manually determined. However, quantitative evaluation cannot be performed on impact of an energy yield loss of the faulty module, manners for processing the faulty module are limited, and costs are excessively high.

### SUMMARY

The embodiments include a power station operation and maintenance system, a power station operation and maintenance method, and a photovoltaic power station, so that a quantitative analysis can be performed on an energy yield loss of a faulty module to select a target operation and maintenance measure from a plurality of operation and maintenance measures, and diversity of operation and maintenance measures and an energy yield of the module are increased. There are low costs, and this is more applicable.

According to a first aspect, the embodiments include a power station operation and maintenance system. The power station operation and maintenance system may be applied to a photovoltaic power station, the photovoltaic power station includes a photovoltaic string, and the power station operation and maintenance system includes a data processing system and a communication system. The data processing system herein may be understood as third-party software and/or hardware having a data processing function. The data processing system may be configured to: determine a faulty module and a normal module based on module data of each photovoltaic module in the photovoltaic string, and obtain first power generation data of the faulty module and second power generation data of the normal module. Further, the data processing system is further configured to: determine an annual lost energy yield of the faulty module based on the first power generation data, the second power generation data, and a preset energy yield (which may also be referred to as a theoretical energy yield or a quantity of use hours per year) of the photovoltaic power station, and obtain a target operation and maintenance measure from a plurality of operation and maintenance measures based on the annual lost energy yield. In this case, the communication system may notify, based on the target operation and maintenance measure, an operation and maintenance user of the photovoltaic power station to perform operation and maintenance on the faulty module, to increase an energy yield. In the embodiments, a quantitative analysis may be performed on an energy yield loss of the faulty module based on the first power generation data, the second power generation data, and the preset energy yield of the photovoltaic power station. In addition, the target operation and maintenance measure may be determined from the plurality of operation and maintenance measures based on the annual lost energy yield of the faulty module, so that an energy yield of a module is increased optimally at lowest costs, and diversity of operation and maintenance measures is increased. There also are low costs and a convenient operation, and an energy yield and health of the photovoltaic power station are further improved.

With reference to the first aspect, in a first possible implementation, the data processing system may be configured to: obtain longitude and latitude location information of the faulty module, and determine a target location of the faulty module based on the longitude and latitude location information of the faulty module and a module layout map of the photovoltaic power station. The module layout map herein includes plane location information of all photovoltaic modules in the photovoltaic power station, and may be used to position the target location of the faulty module. Further, the data processing system is further configured to: obtain the first power generation data of the faulty module based on the target location, and obtain the second power generation data of the normal module based on an adjacent location of the target location in the module layout map. In the power station operation and maintenance system provided in the embodiments, the target location of the faulty module may be positioned based on the longitude and latitude location information of the faulty module and the module layout map, and the first power generation data and the second power generation data are obtained based on the target location and the adjacent location of the target location, so that the quantitative analysis is performed on the energy yield loss of the faulty module.

With reference to the first possible implementation of the first aspect, in a second possible implementation, the module data of the photovoltaic module includes module image data of the photovoltaic module, and the power station operation and maintenance system further includes an unmanned aerial vehicle and a data collection terminal disposed on the unmanned aerial vehicle. The data collection terminal may include a visible-light data collection terminal, a thermal infrared data collection terminal, a short-wave infrared data collection terminal, and/or another data collection terminal. The module image data includes visible-light image data, thermal infrared image data, short-wave infrared image data, and/or other image data. The data collection terminal may be configured to collect the module image data of each photovoltaic module. The module image data may carry a photographing height, a photographing tilt angle, and longitude and latitude information of the unmanned aerial vehicle that exist when the data collection terminal photographs the photovoltaic module. Further, the data processing system is further configured to: determine the faulty module based on the module image data of each photovoltaic module, and determine the longitude and latitude location information of the faulty module based on the photographing height, the photographing tilt angle, and the longitude and latitude information of the unmanned aerial vehicle that are in the module image data of the faulty module. In the power station operation and maintenance system provided in the embodiments, fault detection may be performed on the module image data of each photovoltaic module to determine the faulty module, and the longitude and latitude location information of the faulty module may be determined based on the module image data of the faulty module, so that a location of the faulty module is positioned.

With reference to the second possible implementation of the first aspect, in a third possible implementation, the module data of the photovoltaic module further includes an IV curve (also referred to as a volt-ampere characteristic curve), the photovoltaic power station includes a plurality of photovoltaic strings, and the data processing system includes a data processing unit and at least one photovoltaic inverter connected to the plurality of photovoltaic strings. Each photovoltaic inverter may be configured to: collect an IV curve of each photovoltaic string, and output the IV curve of each photovoltaic string to the data processing unit. In this case, the data processing unit may be configured to determine a faulty photovoltaic string (that is, a photovoltaic string including the faulty module) based on the IV curve of each photovoltaic string. After the faulty photovoltaic string is determined, the data collection terminal may be configured to collect module image data of each photovoltaic module in the faulty photovoltaic string. The module image data of each photovoltaic module herein may be used to determine the faulty module. In the power station operation and maintenance system provided in the embodiments, after the faulty photovoltaic string is detected, the module image data of each photovoltaic module in the faulty photovoltaic string may be obtained, without a need to obtain the module image data of all photovoltaic modules in the photovoltaic power station, so that costs are reduced, and operations are more convenient.

With reference to the first possible implementation of the first aspect, in a fourth possible implementation, the data processing system includes a data processing unit and a photovoltaic inverter connected to the photovoltaic string. After the target location of the faulty module is determined, the photovoltaic inverter may be configured to: collect a first IV curve of the faulty module based on the target location, and collect a second IV curve of the normal module based on the adjacent location of the target location, to quickly collect an IV curve of a module based on the target location and the adjacent location of the target location. The data processing unit may be configured to: determine a first peak power of the faulty module based on the first IV curve, and determine the first peak power as the first power generation data of the faulty module. In this case, the data processing unit is further configured to: determine a second peak power of the normal module based on the second IV curve, and determine the second peak power as the second power generation data of the normal module. In the power station operation and maintenance system provided in the embodiments, the first IV curve and the second IV curve may be quickly collected to obtain the first power generation data and the second power generation data, so that the quantitative analysis can be performed on the energy yield loss of the faulty module.

With reference to the first possible implementation of the first aspect, in a fifth possible implementation, the data processing system includes a data processing unit, a power station monitoring system, and a photovoltaic inverter connected to the photovoltaic string. After the target location of the faulty module is determined, the power station monitoring system may be configured to: collect a first energy yield of the faulty module in a target period based on the target location, and collect a second energy yield of the normal module in the target period based on the adjacent location of the target location. The photovoltaic inverter may be configured to collect an IV curve of the normal module based on the adjacent location of the target location, so that the IV curve of and the energy yield of the module can be quickly collected based on the target location and the adjacent location of the target location. In this case, the data processing unit may be configured to: determine the first energy yield as the first power generation data of the faulty module, determine a peak power of the normal module based on the IV curve of the normal module, and determine the second energy yield and the peak power of the normal module as the second power generation data of the normal module. In the power station operation and maintenance system provided in the embodiments, the first energy yield, the second energy yield, and the IV curve of the normal module may be quickly collected to obtain the first power generation data and the second power generation data, so that the quantitative analysis can be performed on the energy yield loss of the faulty module.

With reference to any one of the first aspect to the fifth possible implementation of the first aspect, in a sixth possible implementation, the data processing system may be configured to: obtain an operation and maintenance parameter of each operation and maintenance measure in the plurality of operation and maintenance measures, and obtain, based on the annual lost energy yield of the faulty module and the operation and maintenance parameter of each operation and maintenance measure, each operation and maintenance evaluation value corresponding to each operation and maintenance measure. The operation and maintenance parameter herein may include an operation and maintenance cost, a benefit parameter, and an on-grid power tariff, and the benefit parameter may be determined by an annual energy yield that is increased based on the operation and maintenance measure. Further, the data processing system is further configured to: determine a smallest operation and maintenance evaluation value from all the operation and maintenance evaluation values, and when the smallest operation and maintenance evaluation value is less than an operation and maintenance evaluation threshold, determine an operation and maintenance measure with the smallest operation and maintenance evaluation value as a target operation and maintenance measure. In the power station operation and maintenance system provided in the embodiments, quantitative evaluation may be performed on the operation and maintenance cost, the benefit parameter, the on-grid power tariff of the operation and maintenance measure, and the annual lost energy yield of the faulty module to obtain an optimal target operation and maintenance measure, so that an energy yield of a module is increased optimally at lowest costs. Implementation of these embodiments can provide for convenient operation.

With reference to any one of the first aspect to the sixth possible implementation of the first aspect, in a seventh possible implementation, the communication system may be configured to notify, based on the target operation and maintenance measure, the operation and maintenance user to replace a diode (for example, a diode that fails or is faulty) connected in parallel to the faulty module, to increase the energy yield. In the power station operation and maintenance system provided in the embodiments, the operation and maintenance user may be notified to replace the diode in a timely manner to repair the faulty module, so that the energy yield of the module can be better increased. Implementation of these embodiments can provide lower costs.

With reference to any one of the first aspect to the sixth possible implementation of the first aspect, in an eighth possible implementation, the communication system may be configured to notify, based on the target operation and maintenance measure, the operation and maintenance user to connect an optimizer (a module that has power degradation, a hidden crack, shading, and different electrical performance) at two ends of the faulty module in parallel, to adjust a voltage, a current, and/or an output power of the faulty module, so as to increase the energy yield. In the power station operation and maintenance system provided in the embodiments, the operation and maintenance user may be notified to adjust the voltage, the current, and/or the output power based on the optimizer to repair the faulty module, so that the energy yield of the module can be better increased. Implementation of these embodiments can provide lower costs.

With reference to any one of the first aspect to the sixth possible implementation of the first aspect, in a ninth possible implementation, the communication system may be configured to notify, based on the target operation and maintenance measure, an operation and maintenance user to replace a faulty module (for example, a completely damaged module), to increase the energy yield. In the power station operation and maintenance system provided in the embodiments, the operation and maintenance user may be notified to replace the faulty module, to greatly increase the energy yield of the module.

With reference to any one of the first aspect to the sixth possible implementation of the first aspect, in a tenth possible implementation, the communication system may be configured to notify, based on the target operation and maintenance measure, the operation and maintenance user to connect an external device at two ends of the faulty module (for example, a module with light induced degradation and aging degradation) in parallel, to apply a reverse voltage or a reverse current to the two ends of the faulty module, so as to increase the energy yield. In the power station operation and maintenance system provided in the embodiments, the operation and maintenance user may be notified to apply the reverse voltage, or the reverse current, based on the external device to repair the faulty module, so that the energy yield of the module can be better increased. Implementation of these embodiments can provide lower costs.

With reference to any one of the first aspect to the sixth possible implementation of the first aspect, in an eleventh possible implementation, the communication system may be configured to notify, based on the target operation and maintenance measure, the operation and maintenance user to apply a positive voltage to a voltage to earth of the faulty module (for example, a module with potential induced degradation), to increase the energy yield. In the power station operation and maintenance system provided in the embodiments, the operation and maintenance user may be notified to apply the positive voltage to the voltage to earth of the faulty module to repair the faulty module, so that the energy yield of the module can be better increased. Implementation of these embodiments can provide lower costs.

According to a second aspect, the embodiments provide a power station operation and maintenance method. The method is applicable to the data processing system in the power station operation and maintenance system provided in any one of the first aspect to the eleventh possible implementation of the first aspect. In the method, the data processing system may determine a faulty module and a normal module based on module data of each photovoltaic module in a photovoltaic string, and obtain first power generation data of the faulty module and second power generation data of the normal module. Further, the data processing system may determine an annual lost energy yield of the faulty module based on the first power generation data, the second power generation data, and a preset energy yield of a photovoltaic power station, and obtain a target operation and maintenance measure from a plurality of operation and maintenance measures based on the annual lost energy yield of the faulty module. In this case, the data processing system may notify, based on the target operation and maintenance measure by using a communication system, an operation and maintenance user of the photovoltaic power station to perform operation and maintenance on the faulty module, to increase an energy yield.

With reference to the second aspect, in a first possible implementation, before obtaining the first power generation data of the faulty module and the second power generation data of the normal module, the data processing system may obtain longitude and latitude location information of the faulty module, and determine a target location of the faulty module based on the longitude and latitude location information of the faulty module and a module layout map of the photovoltaic power station. Further, the data processing system may obtain the first power generation data of the faulty module based on the target location, and obtain the second power generation data of the normal module based on an adjacent location of the target location in the module layout map.

With reference to the first possible implementation of the second aspect, in a second possible implementation, the data processing system may collect module image data of each photovoltaic module by using a data collection terminal. The module image data herein carries a photographing height, a photographing tilt angle, and longitude and latitude information of an unmanned aerial vehicle that exist when the data collection terminal photographs the photovoltaic module. In this case, the data processing system may determine the faulty module based on the module image data of each photovoltaic module, and determine longitude and latitude location information of the faulty module based on the photographing height, the photographing tilt angle, and the longitude and latitude information of the unmanned aerial vehicle that are in the module image data of the faulty module.

With reference to the second possible implementation of the second aspect, in a third possible implementation, before collecting the module image data of each photovoltaic module by using the data collection terminal, the data processing system may scan an IV curve of each photovoltaic string by using each photovoltaic inverter, and determine a faulty photovoltaic string based on the IV curve of each photovoltaic string. Further, the data processing system may collect the module image data of each photovoltaic module in the faulty photovoltaic string by using the data collection terminal. The module image data of each photovoltaic module may be used to determine the faulty module.

With reference to the first possible implementation of the second aspect, in a fourth possible implementation, the data processing system may collect a first IV curve of the faulty module based on the target location by using the photovoltaic inverter, and collect a second IV curve of the normal module based on the adjacent location of the target location in the module layout map. Further, the data processing system may determine a first peak power of the faulty module based on the first IV curve, and determine the first peak power as the first power generation data of the faulty module. In this case, the data processing system may determine a second peak power of the normal module based on the second IV curve, and determine the second peak power as the second power generation data of the normal module.

With reference to the first possible implementation of the second aspect, in a fifth possible implementation, the data processing system may collect a first energy yield of the faulty module in a target period based on the target location by using a power station monitoring system, and collect, based on the adjacent location of the target location in the module layout map, a second energy yield of the normal module in the target period. The data processing system may collect an IV curve of the normal module based on the adjacent location of the target location by using the photovoltaic inverter. Further, the data processing system may determine the first energy yield as the first power generation data of the faulty module, determine a peak power of the normal module based on the IV curve of the normal module, and determine the second energy yield and the peak power of the normal module as the second power generation data of the normal module.

With reference to any one of the second aspect to the fifth possible implementation of the second aspect, in a sixth possible implementation, the data processing system may obtain an operation and maintenance parameter of each operation and maintenance measure in the plurality of operation and maintenance measures, and obtain, based on the annual lost energy yield of the faulty module and the operation and maintenance parameter of each operation and maintenance measure, each operation and maintenance evaluation value corresponding to each operation and maintenance measure. The operation and maintenance parameter herein includes an operation and maintenance cost, a benefit parameter, and an on-grid power tariff, and the benefit parameter may be determined by an annual energy yield that is increased based on the operation and maintenance measure. After obtaining each operation and maintenance evaluation value, the data processing system may determine a smallest operation and maintenance evaluation value from all the operation and maintenance evaluation values, and when the smallest operation and maintenance evaluation value is less than an operation and maintenance evaluation threshold, determine an operation and maintenance measure with the smallest operation and maintenance evaluation value as a target operation and maintenance measure.

With reference to any one of the second aspect to the sixth possible implementation of the second aspect, in a seventh possible implementation, the data processing system may notify, based on the target operation and maintenance measure by using the communication system, the operation and maintenance user of the photovoltaic power station to replace a diode connected in parallel to the faulty module, to increase the energy yield.

With reference to any one of the second aspect to the sixth possible implementation of the second aspect, in an eighth possible implementation, the data processing system may notify, based on the target operation and maintenance measure by using the communication system, the operation and maintenance user of the photovoltaic power station to connect an optimizer at two ends of the faulty module in parallel, to adjust a voltage, a current, and/or an output power of the faulty module, so as to increase the energy yield.

With reference to any one of the second aspect to the sixth possible implementation of the second aspect, in a ninth possible implementation, the data processing system may notify, based on the target operation and maintenance measure by using the communication system, the operation and maintenance user of the photovoltaic power station to replace the faulty module, to increase the energy yield.

With reference to any one of the second aspect to the sixth possible implementation of the second aspect, in a tenth possible implementation, the data processing system may notify, based on the target operation and maintenance measure, the operation and maintenance user of the photovoltaic power station to connect an external device at two ends of the faulty module in parallel, to apply a reverse voltage or a reverse current to the two ends of the faulty module, so as to increase the energy yield.

With reference to any one of the second aspect to the sixth possible implementation of the second aspect, in an eleventh possible implementation, the data processing system may notify, based on the target operation and maintenance measure by using the communication system, the operation and maintenance user of the photovoltaic power station to apply a positive voltage to a voltage to earth of the faulty module, to increase the energy yield.

According to a third aspect, the embodiments provide a photovoltaic power station. The photovoltaic power station includes a plurality of photovoltaic strings and the power station operation and maintenance system provided in any one of the first aspect to the eleventh possible implementation of the first aspect. In the embodiments, the power station operation and maintenance system may be used to perform operation and maintenance on the faulty module in the plurality of photovoltaic strings, so that benefits and health of the photovoltaic power station are improved.

In the embodiments, a quantitative analysis may be performed on an energy yield loss of the faulty module. In addition, an energy yield of a module can be increased optimally at lowest costs, and diversity of operation and maintenance measures is improved. There are low costs and a convenient operation, and an energy yield and health of the photovoltaic power station are further improved.

### BRIEF DESCRIPTION OF DRAWINGS

FIG. 1 is a schematic diagram of an application scenario of a power station operation and maintenance system according to the embodiments;

FIG. 2 is a schematic diagram of a structure of a power station operation and maintenance system according to the embodiments;

FIG. 3 is a schematic diagram of another structure of a power station operation and maintenance system according to the embodiments;

FIG. 4 is a schematic diagram of still another structure of a power station operation and maintenance system according to the embodiments;

FIG. 5 is a schematic diagram of yet another structure of a power station operation and maintenance system according to the embodiments; and

FIG. 6 is a schematic flowchart of a power station operation and maintenance method according to the embodiments.

### DETAILED DESCRIPTION OF EMBODIMENTS

A power station operation and maintenance system provided in the embodiments may be applied to a plurality of application fields, such as a power inspection field (for example, inspection and operation and maintenance are performed on a power station with weak communication or an insufficient bandwidth), a monitoring field (for example, intelligent security protection), an environmental protection field (for example, environment monitoring, environmental law enforcement, and environment governance), or a reconnaissance field. This may be determined based on an actual application scenario, and is not limited herein.

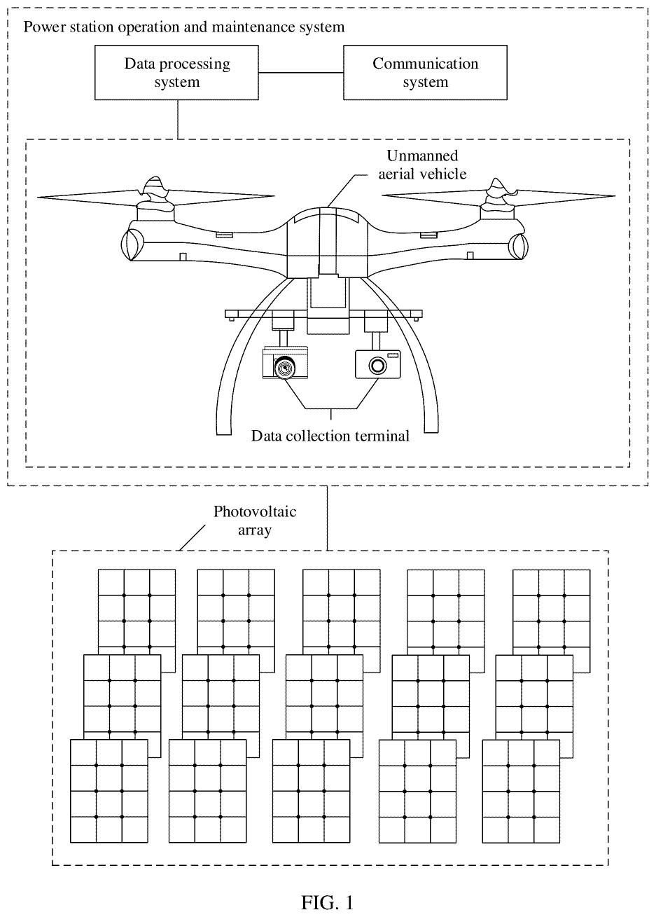

FIG. 1 is a schematic diagram of an application scenario of a power station operation and maintenance system according to the embodiments. The power station operation and maintenance system provided in the embodiments may be applied to a photovoltaic power station. The photovoltaic power station further includes a plurality of photovoltaic strings, and the plurality of photovoltaic strings herein may form a photovoltaic array. As shown in FIG. 1, the power station operation and maintenance system may include a data processing system, a communication system, an unmanned aerial vehicle, and a data collection terminal disposed on the unmanned aerial vehicle. In a process in which the power station operation and maintenance system performs operation and maintenance on a faulty module in the photovoltaic array, the data collection terminal may collect module image data (for example, a picture or a video) of each photovoltaic module in the photovoltaic array in real time in a process in which the unmanned aerial vehicle flies. In this case, the data processing system may determine the faulty module (for example, a photovoltaic module with an abnormal energy yield) and a normal module from the photovoltaic array based on the module image data of each photovoltaic module, and obtain first power generation data of the faulty module and second power generation data of the normal module. Further, the data processing system may determine an annual lost energy yield of the faulty module based on the first power generation data, the second power generation data, and a preset energy yield of the photovoltaic power station, and obtain a target operation and maintenance measure from a plurality of operation and maintenance measures based on the annual lost energy yield. After the target operation and maintenance measure is determined, the communication system may notify, based on the target operation and maintenance measure, an operation and maintenance person of the power station to perform operation and maintenance on the faulty module to increase an energy yield, so that an energy yield of a module can be increased optimally at lowest costs. There are low costs and a convenient operation, and health and an energy yield of the photovoltaic power station are further improved.

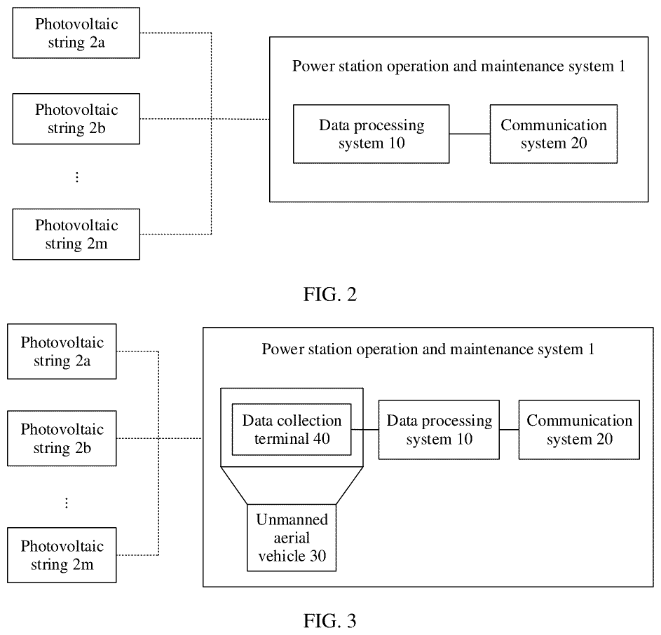

The following provides example descriptions of the power station operation and maintenance system provided in the embodiments, and a working principle of the power station operation and maintenance system with reference to FIG. 2 to FIG. 5.

FIG. 2 is a schematic diagram of a structure of a power station operation and maintenance system according to the embodiments. As shown in FIG. 2, a power station operation and maintenance system 1 includes a data processing system 10 and a communication system 20. The power station operation and maintenance system 1 may be applied to a photovoltaic power station, and the photovoltaic power station further includes a plurality of photovoltaic strings (for example, a photovoltaic string 2a to a photovoltaic string 2m). One photovoltaic string may be formed by connecting at least one photovoltaic module (that is, one or more photovoltaic modules) in series/parallel, and the photovoltaic module may also be referred to as a solar panel or a photovoltaic panel. In the embodiments, third-party software and/or hardware that have/has a data processing function in the power station operation and maintenance system may be collectively referred to as a data processing system. In the embodiments, one or more modules in the power station operation and maintenance system that have a function of communicating with an operation and maintenance person of the power station may be further collectively referred to as a communication system. For example, the communication system may be configured to notify an operation and maintenance user of the photovoltaic power station to perform operation and maintenance on a faulty module, to increase an energy yield of the module.

In some implementations, for ease of description, the photovoltaic string 2a is used as an example for description. The data processing system 10 may determine a faulty module and a normal module based on module data of each photovoltaic module in the photovoltaic string 2a, and obtain first power generation data of the faulty module and second power generation data of the normal module. The module data herein may include module image data, an IV curve (which may also be referred to as a volt-ampere characteristic curve), and/or other data of the photovoltaic module. The IV curve is a characteristic curve that describes a corresponding change of an output current when an output voltage of the photovoltaic module changes from a short-circuit voltage to an open-circuit voltage. The faulty module can be understood as a photovoltaic module with an abnormal energy yield, for example, a photovoltaic module whose diode fails or is faulty, a photovoltaic module that has power degradation, a hidden crack, shading, and different electrical performance, or a completely damaged photovoltaic module. The power degradation herein may include light induced degradation (LID), aging degradation, and potential induced degradation (PID). Light induced degradation is that an output power decreases because a composite center is generated inside a material after the photovoltaic module is exposed to light. Aging degradation is that the photovoltaic module is slowly degraded in a long-term application. Potential induced degradation is that a module power is degraded due to a high voltage between a circuit inside the photovoltaic module and a ground metal frame of the photovoltaic module. Further, the data processing system 10 may determine an annual lost energy yield of the faulty module based on the first power generation data, the second power generation data, and a preset energy yield (which may also be referred to as a theoretical energy yield or a quantity of use hours per year) of the photovoltaic power station, and obtain a target operation and maintenance measure from a plurality of operation and maintenance measures based on the annual lost energy yield. The preset energy yield may be a default configuration parameter of the photovoltaic power station, or an energy yield that is set by a user for the photovoltaic power station. This may be determined based on an actual application scenario, and is not limited herein. In this case, the communication system 20 may notify, based on the target operation and maintenance measure, the operation and maintenance user of the photovoltaic power station to perform operation and maintenance on the faulty module in the photovoltaic string 2a, to increase an energy yield of the module after operation and maintenance, so that the energy yield of the module is increased optimally at lowest costs. There are low costs and a convenient operation.

In some implementations, FIG. 3 is a schematic diagram of another structure of a power station operation and maintenance system according to the embodiments. As shown in FIG. 3, when the module data of the photovoltaic module includes the module image data, the power station operation and maintenance system 1 shown in FIG. 2 further includes an unmanned aerial vehicle 30 and a data collection terminal 40 disposed on the unmanned aerial vehicle 30. In the embodiments, one or more terminal devices that have a data collection function in the power station operation and maintenance system may be collectively referred to as a data collection terminal. For example, the data collection terminal may be a camera device, a sensor, or another terminal device. The camera device herein may be a visible-light camera, a thermal infrared dual-light camera, an electroluminescent (EL) camera, or another camera device. The EL camera may also be referred to as a short-wave infrared camera. The thermal infrared dual-light camera may be a camera that detects an infrared specific band signal of thermal radiation of an object by using a photoelectric technology and converts the signal into an image and a graph that may be visually distinguished by a human. The short-wave infrared camera may be a camera that detects a short-wave infrared specific band signal (which may be within a range of 0.9 μm to 1.7 μm) by using the photoelectric technology and converts the band signal into an image and a graph that may be visually distinguished by the human. The data collection terminal 40 may collect (for example, photograph) module image data of each photovoltaic module in the photovoltaic string 2a in real time in a process in which the unmanned aerial vehicle 30 flies. The module image data may carry a photographing height, a photographing tilt angle, and longitude and latitude information of the unmanned aerial vehicle 30 that exist when the data collection terminal 40 photographs the photovoltaic module. Communication may be established between the data collection terminal 40 and the data processing system 10. In this case, the data processing system 10 may obtain the module image data of each photovoltaic module in the photovoltaic string 2a from the data collection terminal 40, and determine the faulty module based on the module image data of each photovoltaic module.

In some implementations, the module image data of the photovoltaic module includes visible-light image data, thermal infrared image data, short-wave infrared image data, and/or other image data. It can be understood that the visible-light image data herein may directly display some surface faults of the photovoltaic module, to quickly and subsequently determine whether the photovoltaic module is a faulty module. The thermal infrared image data may display temperatures of parts of the photovoltaic module and a distribution of the temperatures. Different temperatures or thermal infrared areas (for example, regional areas) of the parts of the photovoltaic module may be determined based on regions of different colors in the thermal infrared image data, to subsequently and directly determine a test temperature of the photovoltaic module or a thermal infrared area of the module, and further determine, based on the test temperature or the thermal infrared area of the module, whether the photovoltaic module has a thermal infrared fault. When the module image data includes the visible-light image data, the data processing system 10 may determine, based on the visible-light image data, whether the photovoltaic module has a surface fault, and when the photovoltaic module has a surface fault, determine that the photovoltaic module is a faulty module. When the module image data includes the thermal infrared image data, the data processing system 10 may perform thermal infrared fault detection on the thermal infrared image data to determine a faulty module. For example, the data processing system 10 may determine the test temperature or the thermal infrared area of the photovoltaic module based on the thermal infrared image data; and if the test temperature is greater than a preset temperature threshold or the thermal infrared area is greater than a threshold area threshold, determine that the photovoltaic module is a faulty module with a thermal infrared fault (for example, a hot spot). The preset temperature threshold or the threshold area threshold herein may be a default value (that is, a default value specified when the photovoltaic module is delivered from a factory). The preset temperature threshold is used as an example for description. For example, the preset temperature threshold may be 30 degrees Celsius or another temperature value. In some embodiments, a test temperature of the faulty module is approximately 10 degrees Celsius higher than the preset temperature threshold or another temperature value.

In some implementations, the short-wave infrared image data may display a defect form of the photovoltaic module, to subsequently determine that the photovoltaic module has a target defect. When the module image data includes the short-wave infrared image data, the data processing system 10 may perform short-wave infrared fault detection on the short-wave infrared image data to determine a faulty module. For example, the data processing system 10 may determine a form of the photovoltaic module based on the short-wave infrared image data, and if the form of the photovoltaic module is included in a defect form sample database, determine that the photovoltaic module is a faulty module with a target defect. The defect sample database herein may be a sample database that is pre-stored in the data processing system 10 and that includes a defect form of a photovoltaic module, or the data processing system 10 may directly invoke a defect form sample database of a photovoltaic module in third-party software. The defect sample database may include sample data of a plurality of defect forms of the photovoltaic module. The plurality of defect forms may include a hidden crack defect form, a fragment defect form, a poor soldering defect form, a broken gate defect form, a bypass diode defect form (a defect form formed because a bypass diode in the photovoltaic module is faulty), a hotspot defect form (that is, a physical damage exists inside the photovoltaic module), another defect form, or the like. For example, the data processing system 10 may determine a form of the photovoltaic module (the form herein may be a defect form or a normal module form) based on the short-wave infrared image data, match the form of the photovoltaic module with a plurality of defect forms in the defect form sample database, and if a target defect form matching the form of the photovoltaic module is found from the plurality of defect forms, determine that the form of the photovoltaic module is included in the defect form sample database, and determine that the photovoltaic module has a target defect corresponding to the target defect form, that is, the photovoltaic module is a faulty module having the target defect. It can be understood that, when a matching degree (that is, a similarity, for example, 80% or another value) between the form of the photovoltaic module and a defect form is greater than a matching degree threshold, the data processing system 10 may determine that the defect form is the target defect form that matches the form of the photovoltaic module. The matching degree threshold herein may be a value specified by the user or a default value.

In some implementations, after determining the faulty module in the photovoltaic string 2a, the data processing system 10 may determine longitude and latitude location information of the faulty module based on the photographing height, the photographing tilt angle, and the longitude and latitude information of the unmanned aerial vehicle 30 that are in the module image data of the faulty module. The longitude and latitude location information herein may be physical location information, and the physical location information may be understood as location information calibrated based on geographic information. Further, the data processing system 10 may obtain the longitude and latitude location information of the faulty module, and determine a target location of the faulty module based on the longitude and latitude location information of the faulty module and a module layout map of the photovoltaic power station. The module layout map includes plane location information of all photovoltaic modules in the photovoltaic power station, and may be used to quickly position the target location of the faulty module. The target location herein may be logical location information, and the logical location information may be understood as logical location information calibrated by using a sequence number, for example, a power station arrangement sequence number (for example, a module F in a string D of an inverter C in a sub-array B of a station A). After positioning the target location of the faulty module, the data processing system 10 may further obtain the first power generation data of the faulty module based on the target location, and obtain the second power generation data of the normal module based on an adjacent location of the target location in the module layout map.

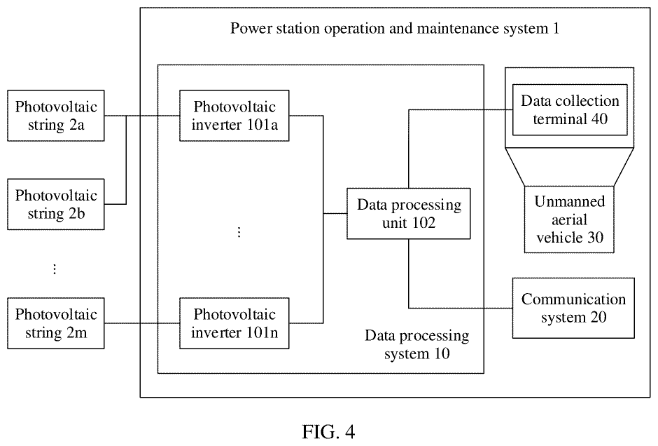

Optionally, in some implementations, when the module data of the photovoltaic module further includes the IV curve, refer to FIG. 4. FIG. 4 is a schematic diagram of still another structure of a power station operation and maintenance system according to the embodiments. As shown in FIG. 4, the data processing system 10 shown in FIG. 3 includes a data processing unit 102 and at least one photovoltaic inverter (for example, a photovoltaic inverter 101a to a photovoltaic inverter 101n) that is connected to a photovoltaic string 2a to a photovoltaic string 2m. One photovoltaic inverter may be connected to at least one photovoltaic string (that is, one or more photovoltaic strings). For example, the photovoltaic inverter 101a is connected to the photovoltaic string 2a and the photovoltaic string 2b, . . . , and the photovoltaic inverter 101n is connected to the photovoltaic string 2m. Each of the photovoltaic inverter 101a to the photovoltaic inverter 101n may collect an IV curve of each of the photovoltaic string 2a to the photovoltaic string 2m, and output the IV curve of each photovoltaic string to the data processing unit 102. In this case, the data processing unit 102 may determine a faulty photovoltaic string (for example, the photovoltaic string 2a) based on the IV curve of each photovoltaic string. After determining the faulty photovoltaic string, the data collection terminal 40 may collect the module image data of each photovoltaic module in the photovoltaic string 2a in real time in the process in which the unmanned aerial vehicle 30 flies. Because communication is established between the data collection terminal 40 and the data processing unit 102, the data processing unit 102 may obtain the module image data of each photovoltaic module in the photovoltaic string 2a from the data collection terminal 40, and determine the faulty module based on the module image data of each photovoltaic module, so that the faulty module can be quickly positioned. There is a more convenient operation. After determining the faulty module in the photovoltaic string 2a, the data processing unit 102 may determine the longitude and latitude location information of the faulty module based on the photographing height, the photographing tilt angle, and the longitude and latitude information of the unmanned aerial vehicle 30 that are in the module image data of the faulty module. Further, the data processing unit 102 may obtain the longitude and latitude location information of the faulty module, and determine the target location of the faulty module based on the longitude and latitude location information of the faulty module and the module layout map of the photovoltaic power station.

In some implementations, the data processing system 10 includes a data processing unit 102 and a photovoltaic inverter 101a connected to the photovoltaic string 2a. After the target location of the faulty module is determined, the photovoltaic inverter 101a may collect a first IV curve of the faulty module based on the target location, and collect a second IV curve of the normal module based on the adjacent location of the target location, to quickly collect an IV curve of a module based on the target location and the adjacent location of the target location. The data processing unit 102 may determine a first peak power of the faulty module based on the first IV curve, and determine the first peak power as the first power generation data of the faulty module. In this case, the data processing unit 102 may further determine a second peak power of the normal module based on the second IV curve, and determine the second peak power as the second power generation data of the normal module. Further, the data processing unit 102 may determine the annual lost energy yield of the faulty module based on the first peak power, the second peak power, and the preset energy yield of the photovoltaic power station. For example, the data processing unit 102 may determine the annual lost energy yield Eₗₒₛₛ of the faulty module based on Formula (1):

Eₗₒₛₛ=(Pₙ−Pₑ)*Eₚ (1)

Herein, Pₙ may represent the first peak power, Pₑ may represent the second peak power, and Eₚ may represent the preset energy yield of the photovoltaic power station.

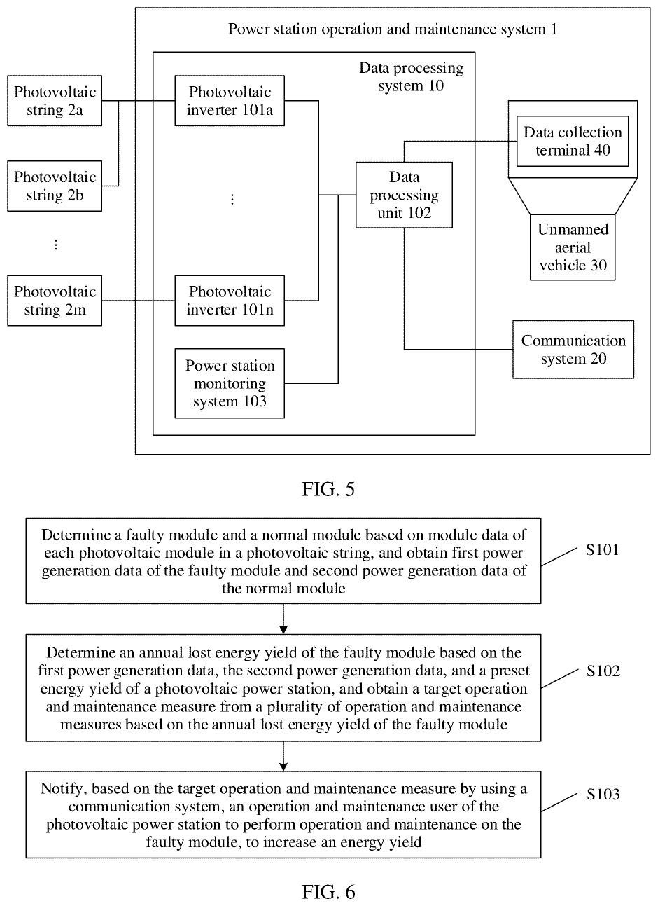

Optionally, in some implementations, FIG. 5 is a schematic diagram of yet another structure of a power station operation and maintenance system according to the embodiments. As shown in FIG. 5, the data processing system 10 shown in FIG. 3 includes a data processing unit 102, a power station monitoring system 103, and a photovoltaic inverter 101a to a photovoltaic inverter 101n that are connected to the photovoltaic string 2a to the photovoltaic string 2m. For ease of description, the photovoltaic inverter 101a is used as an example for description below, and details are not described below again. After determining the target location of the faulty module in the photovoltaic string 2a, the power station monitoring system 103 may collect a first energy yield of the faulty module in a target period (for example, N days) based on the target location, and collect a second energy yield of the normal module in the target period based on the adjacent location of the target location. The photovoltaic inverter 101a may collect an IV curve of the normal module based on the adjacent location of the target location. In this case, the data processing unit 102 may determine the first energy yield as the first power generation data of the faulty module, determine a peak power of the normal module based on the IV curve of the normal module, and determine the second energy yield and the peak power of the normal module as the second power generation data of the normal module. Further, the data processing unit 102 may determine the annual lost energy yield of the faulty module based on the first energy yield, the second energy yield, the peak power of the normal module, and the preset energy yield of the photovoltaic power station. For example, the data processing unit 102 may determine the annual lost energy yield Eₗₒₛₛ of the faulty module based on Formula (2):

Eₗₒₛₛ=(Eₙ−Eₑ)/Eₙ*Pₙ*Eₚ (2)

Herein, Eₑ may represent the first energy yield, Eₙ may represent the second energy yield, Pₑ may represent the peak power of the normal module (that is, the second peak power), and Eₚ may represent the preset energy yield of the photovoltaic power station.

Optionally, in some implementations, after the annual lost energy yield of the faulty module is determined based on Formula (1) or Formula (2), the data processing system 10 (or the data processing unit 102) may obtain an operation and maintenance parameter of each operation and maintenance measure in the plurality of operation and maintenance measures, and obtain, based on the annual lost energy yield of the faulty module and the operation and maintenance parameter of each operation and maintenance measure, each operation and maintenance evaluation value corresponding to each operation and maintenance measure. The operation and maintenance parameter herein may include an operation and maintenance cost, a benefit parameter, and an on-grid power tariff (that is, a price of an energy yield). The benefit parameter may be determined by an annual energy yield that is increased based on the operation and maintenance measure, and the operation and maintenance cost includes a spare part cost, a replacement cost, and a transportation cost. For example, the data processing system 10 may determine, based on Formula (3), the operation and maintenance evaluation value δₙ corresponding to the operation and maintenance measure:

δₙ=Cₙ/(Eₗₒₛₛ*V_{α}*Fₙ) (3)

Herein, Cₙ may represent the operation and maintenance cost, Eₗₒₛₛ may represent the annual lost energy yield of the faulty module, V_{α} may represent the on-grid power tariff, and Fₙ may represent the benefit parameter.

After obtaining each operation and maintenance evaluation value corresponding to each operation and maintenance measure based on Formula (3), the data processing system 10 may further determine a smallest operation and maintenance evaluation value from all the operation and maintenance evaluation values, and when the smallest operation and maintenance evaluation value is less than an operation and maintenance evaluation threshold, determine an operation and maintenance measure with the smallest operation and maintenance evaluation value as a target operation and maintenance measure. The target operation and maintenance measure herein may be understood as an operation and maintenance measure recommended to the operation and maintenance user of the photovoltaic power station. The operation and maintenance evaluation threshold herein may be an expected investment payback period of the photovoltaic power station, and the expected investment payback period may be a default value configured for the photovoltaic power station or an expected value specified by the user. On the contrary, when the smallest operation and maintenance evaluation value is greater than the operation and maintenance evaluation threshold, the data processing system 10 does not recommend the operation and maintenance measure with the smallest operation and maintenance evaluation value to the operation and maintenance user of the photovoltaic power station. In this case, the operation and maintenance user of the photovoltaic power station may further view a specific fault of the faulty module to perform operation and maintenance on the faulty module.

Optionally, in some implementations, the unmanned aerial vehicle 30 and the data collection terminal 40 may form a module data collection system in the power station operation and maintenance system 1. The module data collection system may collect the module data of each photovoltaic module in the photovoltaic string 2a. The data processing system 10 may be integrated with a faulty module analysis system, a faulty module positioning system, a faulty energy yield loss evaluation system, and an optimal operation and maintenance measure output system. The faulty module analysis system may perform artificial intelligence (AI) module fault analysis on the module data of each photovoltaic module, to diagnose a faulty module that has a hidden crack, shading, PID degradation, broken glass, and a short-circuited diode in the photovoltaic string 2a. The AI module fault analysis herein may include thermal infrared fault detection and/or short-wave infrared fault detection. The short-wave infrared fault detection may include electroluminescence (EL) fault detection and photoluminescence (PL) fault detection. Electroluminescence is a physical phenomenon that an electric field is generated based on a voltage applied to two electrodes, and an electron excited by the electric field touches a luminescence center, so that a transition between energy levels, a change, and a combination of electrons are caused to cause luminescence. Photoluminescence is a physical phenomenon that a substance absorbs a photon and then re-radiates the photon. Both of the two physical phenomena may be applied to perform short-wave infrared fault detection on the photovoltaic module. The faulty module positioning system may determine the longitude and latitude location information of the faulty module based on the photographing height, the photographing tilt angle, and the longitude and latitude information of the unmanned aerial vehicle 30 that are carried in the module image data of the faulty module, and determine the target location of the faulty module based on the longitude and latitude location information of the faulty module and the module layout map of the photovoltaic power station. The faulty energy yield loss evaluation system includes an energy yield loss calculation model 1 and an energy yield loss calculation model 2. The energy yield loss calculation model 1 may output the annual lost energy yield of the faulty module based on the first peak power, the second peak power, and the preset energy yield of the photovoltaic power station, and the energy yield loss calculation model 2 may output the annual lost energy yield of the faulty module based on the first energy yield, the second energy yield, the peak power of the normal module, and the preset energy yield of the photovoltaic power station. The optimal operation and maintenance measure output system may include a benefit and cost evaluation model. The benefit and cost evaluation model may output the target operation and maintenance measure (that is, an optimal operation and maintenance measure) based on the annual lost energy yield of the faulty module and the operation and maintenance parameter of each operation and maintenance measure, to implement intelligent operation and maintenance of the photovoltaic power station, and increase operation and maintenance efficiency of the photovoltaic module.

In some implementations, the communication system 20 may recommend the target operation and maintenance measure to the operation and maintenance user of the photovoltaic power station, to notify the operation and maintenance user to perform operation and maintenance on the faulty module based on the target operation and maintenance measure. For example, the communication system 20 may output operation and maintenance information corresponding to the target operation and maintenance measure to a display interface of the power station monitoring system 103, to notify the operation and maintenance user to view the operation and maintenance information and perform operation and maintenance on the faulty module. Optionally, the data processing system 10 (or the data processing unit 102) may generate an operation and maintenance evaluation report based on the target operation and maintenance measure. In this case, the communication system 20 may send the operation and maintenance evaluation report to the operation and maintenance user, to notify the operation and maintenance user to perform operation and maintenance on the faulty module based on the operation and maintenance evaluation report. Optionally, the communication system 20 may further send, to a user terminal interface, an email or an SMS message that includes the operation and maintenance information corresponding to the target operation and maintenance measure, to notify the operation and maintenance user to view the operation and maintenance information and perform operation and maintenance on the faulty module. This may be determined based on an actual application scenario, and is not limited herein.

In some implementations, the communication system 20 may notify, based on the target operation and maintenance measure, the operation and maintenance user to replace a diode (for example, a diode that fails or is faulty) connected in parallel to the faulty module, to increase the energy yield. Optionally, the communication system 20 may notify, based on the target operation and maintenance measure, the operation and maintenance user to connect an optimizer (a module optimization apparatus) at two ends of the faulty module in parallel, to adjust a voltage, a current, and/or an output power of the faulty module, so as to increase the energy yield. In this case, the faulty module may have faults such as power degradation, a hidden crack, shading, and different electrical performance. These faults may be considered as faults that may be optimized and that much affect the energy yield. Optionally, the communication system 20 may notify, based on the target operation and maintenance measure, the operation and maintenance user to replace the faulty module, to increase the energy yield. In this case, the faulty module may be a module with a serious fault, for example, a completely damaged module.

In some implementations, the communication system 20 may notify, based on the target operation and maintenance measure (that is, a reverse excitation correction measure), the operation and maintenance user to connect an external device at two ends of the faulty module in parallel, to apply a reverse voltage or a reverse current to the two ends of the faulty module, so as to increase the energy yield. In this case, the faulty module may be a module with a correctable fault, and the correctable fault may include light induced degradation and aging degradation. Optionally, the communication system 20 may notify, based on the target operation and maintenance measure, the operation and maintenance user to apply a positive voltage to a voltage to earth of the faulty module, so as to increase the energy yield. In this case, the faulty module may be a module with a correctable fault, and the correctable fault may include a module with potential induced degradation. Optionally, the communication system 20 may notify, based on the target operation and maintenance measure, the operation and maintenance user not to process the faulty module. In this case, the faulty module may have a minor fault and has a small lost energy yield. Therefore, the operation and maintenance measure may not be processed. It can be understood that different target operation and maintenance measures may be used to perform operation and maintenance on modules with different types of faults, to optimally increase the energy yield of the module at lowest costs and increase benefits of the photovoltaic power station.

FIG. 6 is a schematic flowchart of a power station operation and maintenance method according to the embodiments. The power station operation and maintenance method provided in the embodiments is applicable to the data processing system of the power station operation and maintenance system provided in FIG. 2 to FIG. 5. As shown in FIG. 6, the method may include step S101 to step S103.

Step S101: Determine a faulty module and a normal module based on module data of each photovoltaic module in a photovoltaic string, and obtain first power generation data of the faulty module and second power generation data of the normal module.

In some implementations, the data processing system may collect module image data of each photovoltaic module by using a data collection terminal. The module image data herein carries a photographing height, a photographing tilt angle, and longitude and latitude information of an unmanned aerial vehicle that exist when the data collection terminal photographs the photovoltaic module. In this case, the data processing system may determine the faulty module based on the module image data of each photovoltaic module, and determine longitude and latitude location information of the faulty module based on the photographing height, the photographing tilt angle, and the longitude and latitude information of the unmanned aerial vehicle that are in the module image data of the faulty module. Optionally, the data processing system may scan an IV curve of each photovoltaic string by using each photovoltaic inverter, and determine a faulty photovoltaic string based on the IV curve of each photovoltaic string. Further, the data processing system may collect the module image data of each photovoltaic module in the faulty photovoltaic string by using the data collection terminal, determine the faulty module based on the module image data of each photovoltaic module, and determine the longitude and latitude location information of the faulty module based on the photographing height, the photographing tilt angle, and the longitude and latitude information of the unmanned aerial vehicle that are in module image data of the faulty module. This may be determined based on an actual application scenario, and is not limited herein.

In some implementations, after obtaining the longitude and latitude location information of the faulty module, the data processing system may determine a target location of the faulty module based on the longitude and latitude location information of the faulty module and a module layout map of a photovoltaic power station. Further, the data processing system may obtain the first power generation data of the faulty module based on the target location, and obtain the second power generation data of the normal module based on an adjacent location (or a near location) of the target location in the module layout map.

In some implementations, the data processing system may collect a first IV curve of the faulty module based on the target location by using the photovoltaic inverter, and collect a second IV curve of the normal module based on the adjacent location of the target location in the module layout map. Further, the data processing system may determine a first peak power of the faulty module based on the first IV curve, and determine the first peak power as the first power generation data of the faulty module. In this case, the data processing system may determine a second peak power of the normal module based on the second IV curve, and determine the second peak power as the second power generation data of the normal module.

Optionally, in some implementations, the data processing system may collect a first energy yield of the faulty module in a target period based on the target location by using a power station monitoring system, and collect, based on the adjacent location of the target location in the module layout map, a second energy yield of the normal module in the target period. The data processing system may collect an IV curve of the normal module based on the adjacent location of the target location by using the photovoltaic inverter. Further, the data processing system may determine the first energy yield as the first power generation data of the faulty module, determine a peak power of the normal module based on the IV curve of the normal module, and determine the second energy yield and the peak power of the normal module as the second power generation data of the normal module.

Step S102: Determine an annual lost energy yield of the faulty module based on the first power generation data, the second power generation data, and a preset energy yield of the photovoltaic power station, and obtain a target operation and maintenance measure from a plurality of operation and maintenance measures based on the annual lost energy yield of the faulty module.

In some implementations, the data processing system may determine the annual lost energy yield of the faulty module based on the first peak power, the second peak power, and the preset energy yield of the photovoltaic power station. For example, a data processing unit 102 may determine the annual lost energy yield Eₗₒₛₛ of the faulty module based on Formula (1):

Eₗₒₛₛ=(Pₙ−Pₑ)*Eₚ (1)

Herein, Pₙ may represent the first peak power, Pₑ may represent the second peak power, and Eₚ may represent the preset energy yield of the photovoltaic power station.

Optionally, in some implementations, the data processing system may determine the annual lost energy yield of the faulty module based on the first energy yield, the second energy yield, the peak power of the normal module, and the preset energy yield of the photovoltaic power station. For example, a data processing unit 102 may determine the annual lost energy yield Eₗₒₛₛ of the faulty module based on Formula (2):

Eₗₒₛₛ=(Eₙ−Eₑ)/Eₙ*Pₙ*Eₚ (2)

Herein, Eₑ may represent the first energy yield, Eₙ may represent the second energy yield, Pₑ may represent the peak power of the normal module (that is, the second peak power), and Eₚ may represent the preset energy yield of the photovoltaic power station.

In some implementations, the data processing system may obtain an operation and maintenance parameter of each operation and maintenance measure in the plurality of operation and maintenance measures, and obtain, based on the annual lost energy yield of the faulty module and the operation and maintenance parameter of each operation and maintenance measure, each operation and maintenance evaluation value corresponding to each operation and maintenance measure. The operation and maintenance parameter herein may include an operation and maintenance cost, a benefit parameter, and an on-grid power tariff, the benefit parameter may be determined by an annual energy yield that is increased based on the operation and maintenance measure, and the operation and maintenance cost includes a spare part cost, a replacement cost, and a transportation cost. The plurality of operation and maintenance measures include diode replacement, optimizer installation, module replacement, module activation and repair, and another operation and maintenance measure. For example, the data processing system 10 may determine, based on Formula (3), the operation and maintenance evaluation value δₙ corresponding to the operation and maintenance measure:

δₙ=Cₙ/(Eₗₒₛₛ*V_{α}*Fₙ) (3)

Herein, Cₙ may represent the operation and maintenance cost, Eₗₒₛₛ may represent the annual lost energy yield of the faulty module, V_{α} may represent the on-grid power tariff, and Fₙ may represent the benefit parameter.

After obtaining each operation and maintenance evaluation value corresponding to each operation and maintenance measure based on Formula (3), the data processing system may determine a smallest operation and maintenance evaluation value from all the operation and maintenance evaluation values, and when the smallest operation and maintenance evaluation value is less than an operation and maintenance evaluation threshold, determine an operation and maintenance measure with the smallest operation and maintenance evaluation value as a target operation and maintenance measure. On the contrary, when the smallest operation and maintenance evaluation value is greater than the operation and maintenance evaluation threshold, the data processing system does not recommend the operation and maintenance measure with the smallest operation and maintenance evaluation value to the operation and maintenance user of the photovoltaic power station. In this case, the operation and maintenance user of the photovoltaic power station may further view a specific fault of the faulty module to perform operation and maintenance on the faulty module.

Step S103: Notify, based on the target operation and maintenance measure by using a communication system, an operation and maintenance user of the photovoltaic power station to perform operation and maintenance on the faulty module, to increase an energy yield.

In some implementations, the data processing system may recommend the target operation and maintenance measure to the operation and maintenance user of the photovoltaic power station by using the communication system, to notify the operation and maintenance user to perform operation and maintenance on the faulty module based on the target operation and maintenance measure. For example, the data processing system may output, by using the communication system, operation and maintenance information corresponding to the target operation and maintenance measure to a display interface of the power station monitoring system, to notify the operation and maintenance user to view the operation and maintenance information and perform operation and maintenance on the faulty module. Optionally, the data processing system may generate an operation and maintenance evaluation report based on the target operation and maintenance measure, and send the operation and maintenance evaluation report to the operation and maintenance user by using the communication system, to notify the operation and maintenance user to perform operation and maintenance on the faulty module based on the operation and maintenance evaluation report. Optionally, the data processing system may send, to a user terminal interface by using the communication system, an email or an SMS message that includes the operation and maintenance information corresponding to the target operation and maintenance measure, to notify the operation and maintenance user to view the operation and maintenance information and perform operation and maintenance on the faulty module. This may be determined based on an actual application scenario, and is not limited herein.

In some implementations, the data processing system may notify, based on the target operation and maintenance measure by using the communication system, the operation and maintenance user of the photovoltaic power station to replace a diode (for example, a diode that fails or is faulty) connected in parallel to the faulty module, to increase the energy yield. Optionally, the data processing system may notify, based on the target operation and maintenance measure by using the communication system, the operation and maintenance user of the photovoltaic power station to connect an optimizer (a module optimization apparatus) at two ends of the faulty module in parallel, to adjust a voltage, a current, and/or an output power of the faulty module, so as to increase the energy yield. In this case, the faulty module may have faults such as power degradation, a hidden crack, shading, and different electrical performance. These faults may be considered as faults that may be optimized and that much affect the energy yield. Optionally, the data processing system may notify, based on the target operation and maintenance measure by using the communication system, the operation and maintenance user of the photovoltaic power station to replace the faulty module, to increase the energy yield. In this case, the faulty module may be a module with a serious fault, for example, a completely damaged module.

In some implementations, the data processing system may notify, based on the target operation and maintenance measure (that is, a reverse excitation correction measure) by using the communication system, the operation and maintenance user of the photovoltaic power station to connect an external device at two ends of the faulty module in parallel, to apply a reverse voltage or a reverse current to the two ends of the faulty module, so as to increase the energy yield. In this case, the faulty module may be a module with a correctable fault, and the correctable fault may include light induced degradation and aging degradation. Optionally, the data processing system may notify, based on the target operation and maintenance measure by using the communication system, the operation and maintenance user of the photovoltaic power station to apply a positive voltage to a voltage to earth of the faulty module, to increase the energy yield. In this case, the faulty module may be a module with a correctable fault, and the correctable fault may include a module with potential induced degradation. Optionally, the data processing system may notify, based on the target operation and maintenance measure by using the communication system, the operation and maintenance user not to process the faulty module. In this case, the faulty module may have a minor fault and has a small lost energy yield. Therefore, the operation and maintenance measure may not be processed.

In a specific implementation, for more operations performed by the data processing system in the power station operation and maintenance method provided in the embodiments, refer to the implementations performed by the data processing system in the power station operation and maintenance system shown in FIG. 2 to FIG. 5 and the working principles of the data processing system. Details are not described herein again.

In the embodiments, a quantitative analysis may be performed on an energy yield loss of the faulty module. In addition, an energy yield of a module can be increased optimally at low cost costs, and diversity of operation and maintenance measures is improved. Low costs and a convenient operation further improve an energy yield and health of the photovoltaic power station.

The foregoing descriptions are merely implementations of the embodiments, but are not intended to limit the scope of the embodiments. Any variation or replacement readily figured out by a person skilled in the art within the scope of the embodiments shall fall within their scope.

What is claimed is:

1. A power station operation and maintenance system, wherein the power station operation and maintenance system is applicable to a photovoltaic power station, the photovoltaic power station comprises a photovoltaic string, and the power station operation and maintenance system comprises:
a data processing system, and
a communication system;
the data processing system is configured to: determine a faulty module and a normal module based on module data of each photovoltaic module in the photovoltaic string, and obtain first power generation data of the faulty module and second power generation data of the normal module;
the data processing system is further configured to: determine an annual lost energy yield of the faulty module based on the first power generation data, the second power generation data, and a preset energy yield of the photovoltaic power station, and obtain a target operation and maintenance measure from a plurality of operation and maintenance measures based on the annual lost energy yield; and
the communication system is configured to notify, based on the target operation and maintenance measure, an operation and maintenance user of the photovoltaic power station to perform operation and maintenance on the faulty module, to increase an energy yield.

2. The system according to claim 1, wherein the data processing system is further configured to: obtain longitude and latitude location information of the faulty module, and determine a target location of the faulty module based on the longitude and latitude location information of the faulty module and a module layout map of the photovoltaic power station; and
the data processing system is further configured to: obtain the first power generation data of the faulty module based on the target location, and obtain the second power generation data of the normal module based on an adjacent location of the target location in the module layout map.

3. The system according to claim 2, wherein the module data comprises module image data, and the power station operation and maintenance system further comprises an unmanned aerial vehicle and a data collection terminal disposed on the unmanned aerial vehicle;
the data collection terminal is configured to collect the module image data of each photovoltaic module, wherein the module image data carries a photographing height, a photographing tilt angle, and longitude and latitude information of the unmanned aerial vehicle that exist when the data collection terminal photographs the photovoltaic module; and
the data processing system is further configured to: determine the faulty module based on the module image data of each photovoltaic module, and determine the longitude and latitude location information of the faulty module based on the photographing height, the photographing tilt angle, and the longitude and latitude information of the unmanned aerial vehicle that are in module image data of the faulty module.

4. The system according to claim 3, wherein the module data further comprises an IV curve, the photovoltaic power station comprises a plurality of photovoltaic strings, and the data processing system comprises a data processing unit and at least one photovoltaic inverter connected to the plurality of photovoltaic strings;
each photovoltaic inverter is configured to collect an IV curve of each photovoltaic string, and the data processing unit is configured to determine a faulty photovoltaic string based on the IV curve of each photovoltaic string; and
the data collection terminal is further configured to collect module image data of each photovoltaic module in the faulty photovoltaic string.

5. The system according to claim 2, wherein the data processing system comprises a data processing unit and a photovoltaic inverter connected to the photovoltaic string;
the photovoltaic inverter is configured to: collect a first IV curve of the faulty module based on the target location, and collect a second IV curve of the normal module based on the adjacent location of the target location;
the data processing unit is configured to: determine a first peak power of the faulty module based on the first IV curve, and determine the first peak power as the first power generation data of the faulty module; and
the data processing unit is configured to: determine a second peak power of the normal module based on the second IV curve, and determine the second peak power as the second power generation data of the normal module.

6. The system according to claim 2, wherein the data processing system comprises a data processing unit, a power station monitoring system, and a photovoltaic inverter connected to the photovoltaic string;
the power station monitoring system is configured to: collect, based on the target location, a first energy yield of the faulty module in a target period, and collect, based on the adjacent location of the target location, a second energy yield of the normal module in the target period; and the photovoltaic inverter is configured to collect an IV curve of the normal module based on the adjacent location of the target location; and
the data processing unit is configured to: determine the first energy yield as the first power generation data of the faulty module, determine a peak power of the normal module based on the IV curve of the normal module, and determine the second energy yield and the peak power of the normal module as the second power generation data of the normal module.

7. The system according to claim 1, wherein the data processing system is further configured to: obtain an operation and maintenance parameter of each operation and maintenance measure in the plurality of operation and maintenance measures, and obtain, based on the annual lost energy yield of the faulty module and the operation and maintenance parameter of each operation and maintenance measure, each operation and maintenance evaluation value corresponding to each operation and maintenance measure; and
determine a smallest operation and maintenance evaluation value from all the operation and maintenance evaluation values, and when the smallest operation and maintenance evaluation value is less than an operation and maintenance evaluation threshold, determine an operation and maintenance measure with the smallest operation and maintenance evaluation value as a target operation and maintenance measure, wherein
the operation and maintenance parameter comprises an operation and maintenance cost, a benefit parameter, and an on-grid power tariff, and the benefit parameter is determined by an annual energy yield that is increased based on the operation and maintenance measure.

8. The system according to claim 1, wherein the communication system is further configured to notify, based on the target operation and maintenance measure, the operation and maintenance user to replace a diode connected in parallel to the faulty module, to increase the energy yield.

9. The system according to claim 1, wherein the communication system is further configured to notify, based on the target operation and maintenance measure, the operation and maintenance user to connect an optimizer at two ends of the faulty module in parallel, to adjust a voltage, a current, and/or an output power of the faulty module, so as to increase the energy yield.

10. The system according to claim 1, wherein the communication system is further configured to notify, based on the target operation and maintenance measure, the operation and maintenance user to replace the faulty module, to increase the energy yield.

11. The system according to claim 1, wherein the communication system is further configured to notify, based on the target operation and maintenance measure, the operation and maintenance user to connect an external device at two ends of the faulty module in parallel, to apply a reverse voltage or a reverse current to the two ends of the faulty module, so as to increase the energy yield.

12. The system according to claim 1, wherein the communication system is further configured to notify, based on the target operation and maintenance measure, the operation and maintenance user to apply a positive voltage to a voltage to earth of the faulty module, so as to increase the energy yield.

13. A power station operation and maintenance method, wherein the method is applicable to the data processing system in the power station operation and maintenance system according to claim 1, and the method comprises:
determining a faulty module and a normal module based on module data of each photovoltaic module in the photovoltaic string, and obtaining first power generation data of the faulty module and second power generation data of the normal module;
determining an annual lost energy yield of the faulty module based on the first power generation data, the second power generation data, and a preset energy yield of the photovoltaic power station, and obtaining a target operation and maintenance measure from a plurality of operation and maintenance measures based on the annual lost energy yield of the faulty module; and
notifying, based on the target operation and maintenance measure by using a communication system, an operation and maintenance user of the photovoltaic power station to perform operation and maintenance on the faulty module, to increase an energy yield.

14. The method according to claim 13, wherein before obtaining the first power generation data of the faulty module and second power generation data of the normal module, the method further comprises:
obtaining longitude and latitude location information of the faulty module, and determining a target location of the faulty module based on the longitude and latitude location information of the faulty module and a module layout map of the photovoltaic power station; and
obtaining the first power generation data of the faulty module and second power generation data of the normal module comprises:
obtaining the first power generation data of the faulty module based on the target location, and obtaining the second power generation data of the normal module based on an adjacent location of the target location in the module layout map.

15. The method according to claim 14, wherein obtaining the longitude and latitude location information of the faulty module comprises:
collecting the module image data of each photovoltaic module using a data collection terminal, wherein the module image data carries a photographing height, a photographing tilt angle, and longitude and latitude information of the unmanned aerial vehicle that exist when the data collection terminal photographs the photovoltaic module; and
determining the faulty module based on the module image data of each photovoltaic module, and determining the longitude and latitude location information of the faulty module based on the photographing height, the photographing tilt angle, and the longitude and latitude information of the unmanned aerial vehicle that are in module image data of the faulty module.

16. The method according to claim 15, wherein before collecting the module image data of each photovoltaic module by using a data collection terminal, the method further comprises:
scanning an IV curve of each photovoltaic string by using each photovoltaic inverter, and determining a faulty photovoltaic string based on the IV curve of each photovoltaic string; and
collecting the module image data of each photovoltaic module by using a data collection terminal comprises:
collecting module image data of each photovoltaic module in the faulty photovoltaic string by using the data collection terminal.

17. The method according to claim 14, wherein obtaining the first power generation data of the faulty module based on the target location, and obtaining the second power generation data of the normal module based on an adjacent location of the target location in the module layout map comprises:
collecting a first IV curve of the faulty module based on the target location by using the photovoltaic inverter, and collecting a second IV curve of the normal module based on the adjacent location of the target location in the module layout map;
determining a first peak power of the faulty module based on the first IV curve, and determining the first peak power as the first power generation data of the faulty module; and
determining a second peak power of the normal module based on the second IV curve, and determining the second peak power as the second power generation data of the normal module.

18. The method according to claim 14, wherein obtaining the first power generation data of the faulty module based on the target location, and obtaining the second power generation data of the normal module based on an adjacent location of the target location in the module layout map comprises:
collecting a first energy yield of the faulty module in a target period based on the target location by using a power station monitoring system, and collecting, based on the adjacent location of the target location in the module layout map, a second energy yield of the normal module in the target period;
collecting an IV curve of the normal module based on the adjacent location of the target location by using the photovoltaic inverter; and
determining the first energy yield as the first power generation data of the faulty module, determining a peak power of the normal module based on the IV curve of the normal module, and determining the second energy yield and the peak power of the normal module as the second power generation data of the normal module.

19. The method according to claim 13, wherein obtaining a target operation and maintenance measure from a plurality of operation and maintenance measures based on the annual lost energy yield of the faulty module comprises:
obtaining an operation and maintenance parameter of each operation and maintenance measure in the plurality of operation and maintenance measures, and obtaining, based on the annual lost energy yield of the faulty module and the operation and maintenance parameter of each operation and maintenance measure, each operation and maintenance evaluation value corresponding to each operation and maintenance measure; and
determining a smallest operation and maintenance evaluation value from all the operation and maintenance evaluation values, and when the smallest operation and maintenance evaluation value is less than an operation and maintenance evaluation threshold, determining an operation and maintenance measure with the smallest operation and maintenance evaluation value as a target operation and maintenance measure, wherein
the operation and maintenance parameter comprises an operation and maintenance cost, a benefit parameter, and an on-grid power tariff, and the benefit parameter is determined by an annual energy yield that is increased based on the operation and maintenance measure.

20. The method according to claim 13, wherein notifying, based on the target operation and maintenance measure by using the communication system, the operation and maintenance user of the photovoltaic power station to perform operation and maintenance on the faulty module comprises:
notifying, based on the target operation and maintenance measure by using the communication system, the operation and maintenance user of the photovoltaic power station to replace a diode connected in parallel to the faulty module to increase the energy yield.
